(19) United States
(12) Patent Application Publication
(10) Pub. No.: US 2020/0250883 A1
(43) Pub. Date: Aug. 6, 2020

(54) INFORMATION PROCESSING APPARATUS TO SET LIGHTING EFFECT APPLIED TO IMAGE, INFORMATION PROCESSING METHOD, AND STORAGE MEDIUM

(71) Applicant: CANON KABUSHIKI KAISHA, Tokyo (JP)

(72) Inventor: Yuichi Nakada, Yokohama-shi (JP)

(21) Appl. No.: 16/751,965

(22) Filed: Jan. 24, 2020

(30) Foreign Application Priority Data
Jan. 31, 2019 (JP) 2019-016306

(51) Int. Cl. G06T 15/80; G06T 1/00; G06T 7/70; G06T 7/20

(52) U.S. Cl. CPC G06T 15/80; G06T 7/20; G06T 7/70; G06T 1/0007

(57) ABSTRACT

An information processing apparatus includes a first acquisition unit configured to acquire image data representing an image, a second acquisition unit configured to acquire position information of a first object for adjusting a lighting effect applied to the image, and a setting unit configured to set a lighting effect applied to the image based on the position information.

### BACKGROUND

### Field

One disclosed aspect of the embodiments relates to an information processing technique for applying a lighting effect provided by a virtual light source to an image.

### Description of the Related Art

Conventionally, there has been provided a technique for applying a lighting effect to an image by setting a virtual light source. Japanese Patent Application Laid-Open No. 2017-117029 discusses a technique for applying a lighting effect to an image based on a three-dimensional shape of an object.

However, according to the technique discussed in Japanese Patent Application Laid-Open No. 2017-117029, a user has to set a plurality of parameters in order to apply a lighting effect to the image. Thus, there may be a case where a user operation for applying the lighting effect to the image is complicated.

### SUMMARY

One aspect of the embodiments is directed to processing for applying a lighting effect to an image by a simple operation.

An information processing apparatus according to the disclosure includes a first acquisition unit configured to acquire image data illustrating an image, a second acquisition unit configured to acquire position information of a first object for adjusting a lighting effect applied to the image, and a setting unit configured to set a lighting effect applied to the image based on the position information.

Further features of the disclosure will become apparent from the following description of exemplary embodiments with reference to the attached drawings.

### BRIEF DESCRIPTION OF THE DRAWINGS

FIGS. 1A and 1B are block diagrams illustrating hardware configurations of an information processing apparatus.

FIGS. 2A and 2B are diagrams illustrating an example of an external view of the information processing apparatus.

FIG. 3 is a block diagram illustrating a logical configuration of the information processing apparatus.

FIG. 4 is a flowchart illustrating processing executed by the information processing apparatus.

FIG. 5 is a flowchart illustrating processing for acquiring lighting setting information.

FIGS. 6A to 6F are diagrams schematically illustrating the processing for acquiring lighting setting information.

FIG. 7 is a flowchart illustrating processing for setting a lighting effect.

FIGS. 8A to 8F are diagrams schematically illustrating the processing for setting a lighting effect and examples of a display image.

FIGS. 9A to 9D are diagrams schematically illustrating the processing for setting a lighting effect and examples of a display image.

FIGS. 10A to 10D are diagrams illustrating position information of a hand area and examples of a display image.

FIGS. 11A to 11C are diagrams illustrating position information of a hand area and examples of a display image.

FIGS. 12A to 12C are diagrams illustrating position information of a hand area and examples of a display image.

FIG. 13 is a flowchart illustrating processing for acquiring lighting setting information.

FIGS. 14A and 14B are diagrams schematically illustrating the processing for acquiring lighting setting information.

FIG. 15 is a flowchart illustrating processing for setting a lighting effect.

FIGS. 16A to 16C are diagrams illustrating orientation information and examples of a display image.

FIG. 17 is a flowchart illustrating processing for acquiring lighting setting information.

FIGS. 18A to 18C are diagrams illustrating lighting setting information and examples of a display image.

FIG. 19 is a flowchart illustrating processing executed by the information processing apparatus.

FIGS. 20A and 20B are diagrams illustrating examples of a display image.

FIGS. 21A and 21B are diagrams illustrating examples of a shading model map and a shading image.

### DESCRIPTION OF THE EMBODIMENTS

Hereinafter, exemplary embodiments will be described with reference to the appended drawings. Further, the embodiments described below are not intended to limit the disclosure. Furthermore, not all of the combinations of features described in the exemplary embodiments are required as the solutions in the disclosure.

### <Hardware Configuration of Information Processing Apparatus 1>

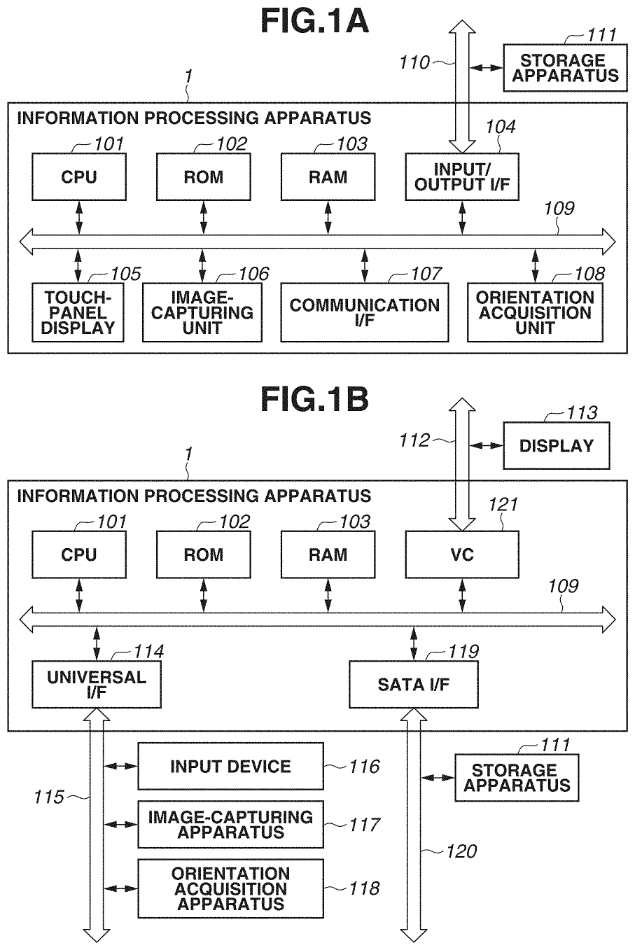

FIG. 1A is a block diagram illustrating an example of a hardware configuration of an information processing apparatus 1. The information processing apparatus 1 is implemented with a device such as a smartphone or a tablet personal computer (PC) having a communication function and an image-capturing function. The information processing apparatus 1 includes a central processing unit (CPU) 101, a read only memory (ROM) 102, a random access memory (RAM) 103, an input/output interface (I/F) 104, a touch-panel display 105, an image-capturing unit 106, a communication I/F 107, and an orientation acquisition unit 108. The CPU 101 uses the RAM 103 as a work memory to execute an operating system (OS) and various programs stored in the ROM 102 and the storage apparatus 111. Further, the CPU 101 controls the components therein via a system bus 109. The CPU 101 loads a program code stored in the ROM 102 or the storage apparatus 111 into the RAM 103, and executes processing illustrated in the below-described flowchart. The storage apparatus 111 is connected to the input/output I/F 104 via a serial bus 110. The storage apparatus 111 is a hard disk drive (HDD), an optical drive, a flash storage device, or any other non-volatile memory, mass or secondary storage devices. The touch-panel display 105 is an input/output unit integrally configured of a display for displaying an image and a touch-panel for detecting a position touched with an instruction member such as a finger. The image-capturing unit 106 acquires an image of an image-capturing target.

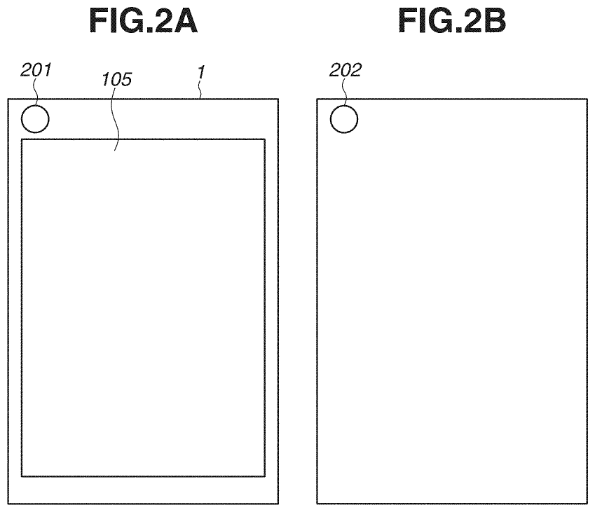

FIGS. 2A and 2B illustrate an example of an external view of the information processing apparatus 1 according to the present exemplary embodiment. FIG. 2A illustrates a face (hereinafter, called as “display face”) having the touch-panel display 105 of the information processing apparatus 1, and FIG. 2B illustrates a face (hereinafter, called as “back face”) opposite to the display face of the information processing apparatus 1. The image-capturing unit 106 in the present exemplary embodiment includes a main-camera 202 arranged on the back face of the information processing apparatus 1 and an in-camera 201 arranged on the display face thereof. The in-camera 201 is disposed at a position and an orientation where a face of a user who is looking at a display (display screen) can be captured. The communication I/F 107 executes wired or wireless bidirectional communication with another information processing apparatus, a communication device, and a storage apparatus. The communication I/F 107 in the present exemplary embodiment can transmit and receive data to and from a communication partner via a wireless local area network (LAN). Further, the communication I/F 107 can execute indirect communication via a relay apparatus with the other communication devices in addition to direct communication. The orientation acquisition unit 108 acquires orientation information indicating an orientation of the touch-panel display 105 included in the information processing apparatus 1 from an inertial sensor.

### <Logical Configuration of Information Processing Apparatus 1>

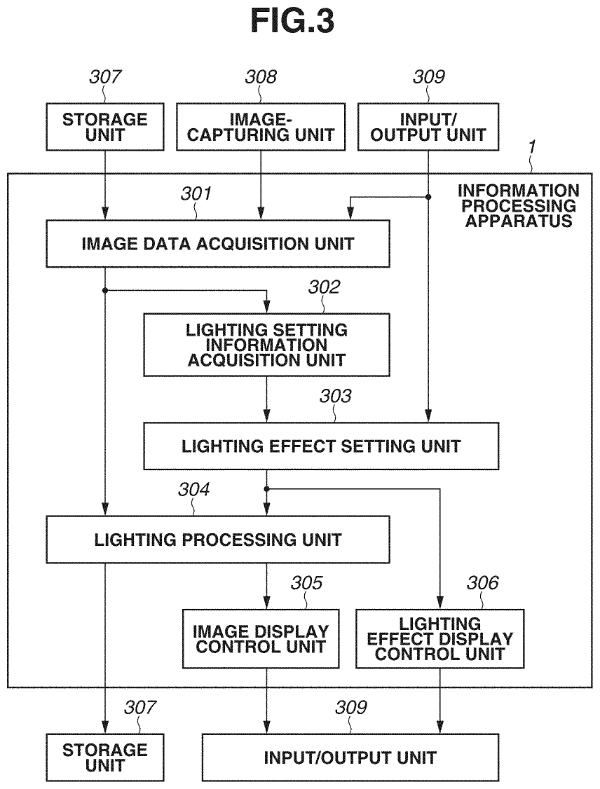

An example of a logical configuration of the information processing apparatus 1 will be described. FIG. 3 is a block diagram illustrating a logical configuration of the information processing apparatus 1 according to the present exemplary embodiment. The CPU 101 uses the RAM 103 as a work memory to execute a program stored in the ROM 102 to cause the information processing apparatus 1 to function as the logical configuration illustrated in FIG. 3. In addition, not all of the processing described below has to be executed by the CPU 101, and the information processing apparatus 1 may be configured in such a manner that all or a part of the processing is executed by one or more processing circuits different from the CPU 101.

The information processing apparatus 1 includes an image data acquisition unit 301, a lighting setting information acquisition unit 302, a lighting effect setting unit 303, a lighting processing unit 304, an image display control unit 305, and a lighting effect display control unit 306. Based on a user instruction acquired by an input/output unit 309, the image data acquisition unit 301 acquires image data from an image-capturing unit 308 or a storage unit 307. The image data acquisition unit 301 acquires three types of image data, i.e., color image data representing a color image as a target to which a lighting effect is applied, distance image data corresponding to the color image data, and normal line image data corresponding to the color image data. The function of the storage unit 307 is achieved by the storage apparatus 111, the function of the image-capturing unit 308 is achieved by the image-capturing unit 106, and the function of the input/output unit 309 is achieved by the touch-panel display 105.

The color image data is image data representing a color image consisting of pixels, each of which has a red (R) value, a green (G) value, and a blue (B) value. The color image data is generated by the image-capturing unit 308 capturing an object. The distance image data is image data representing a distance image consisting of pixels, each of which has a distance value from the image-capturing unit 308 to the object of an image-capturing target. The distance image data is generated based on a plurality of pieces of color image data acquired by capturing the object from different positions. For example, based on pieces of image data acquired by capturing an object through two cameras arranged side by side, or pieces of image data acquired by capturing an object for a plurality of times through a single camera moving at different positions, the distance image data can be generated by a known stereo-matching method. Further, the distance image data may be generated by using a distance acquisition apparatus including an infrared-light emitting unit that emits infrared light to an object and a light receiving unit that receives the infrared light reflected on the object. Specifically, a distance value from a camera to the object can be derived based on time taken for the light receiving unit to receive infrared light that is emitted from the infrared-light emitting unit and reflected on the object.

The normal line image data is image data representing a normal line image consisting of pixels, each of which has a normal vector of a surface of an object as an image-capturing target. The normal vector represents an orientation (normal direction) of the surface of the object. The normal line image data is generated based on the distance image data. For example, a three-dimensional coordinate on the object corresponding to each of pixel positions can be derived based on a distance value of each of the pixels in the distance image, and a normal vector can be derived based on a gradient in three-dimensional coordinates of adjacent pixels. Further, based on three-dimensional coordinates on the object corresponding to respective pixel positions, an approximate plane may be derived for each area having a predetermined size, and a vertical line of the approximate plane may be derived as a normal vector. A method of generating three-dimensional information such as the distance image data and the normal line image data is not limited to the above-described methods. For example, three-dimensional information of the object may be generated by fitting three-dimensional model data corresponding to the object to the object based on color image data. Further, a pixel value at a position in an image represented by each piece of image data acquired by the image data acquisition unit 301 corresponds to a same position on the object.

The lighting setting information acquisition unit 302 acquires lighting setting information for setting a lighting effect applied to the color image based on the image data acquired by the image data acquisition unit 301. The lighting setting information is information regarded as a user operation for applying the lighting effect. In the present exemplary embodiment, information relating to an instruction object to which an instruction about the lighting effect is given is used as the lighting setting information. Based on the lighting setting information acquired by the lighting setting information acquisition unit 302, the lighting effect setting unit 303 sets a lighting effect to be applied to the color image from among a plurality of lighting effects. The lighting processing unit 304 applies the lighting effect set by the lighting effect setting unit 303 to the color image. Further, based on the user operation acquired by the input/output unit 309, the lighting processing unit 304 stores, in the storage unit 307, image data representing an image to which the lighting effect is applied.

The image display control unit 305 uses the input/output unit 309 as a display unit to display the image to which the lighting effect is applied. The lighting effect display control unit 306 displays an icon corresponding to the lighting effect on the input/output unit 309.

### <Processing Executed by Information Processing Apparatus 1>

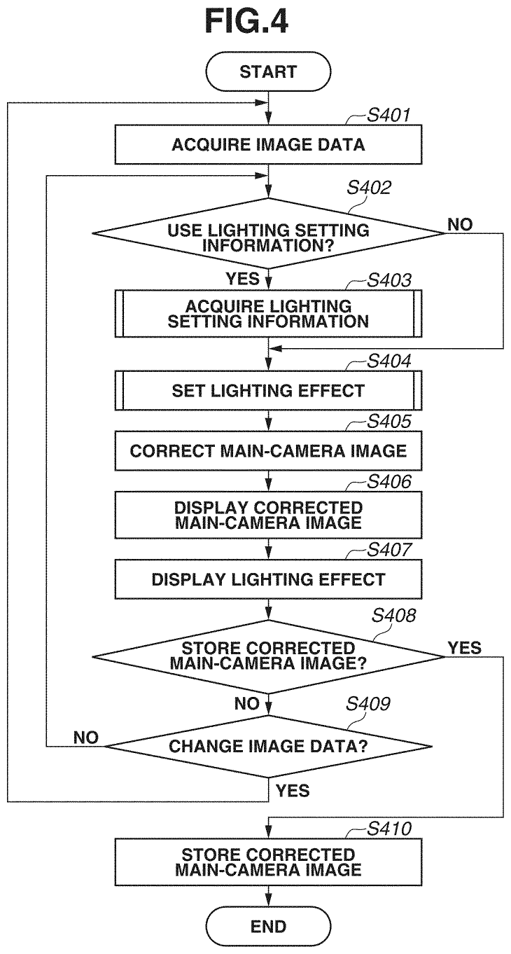

FIG. 4 is a flowchart illustrating processing executed by the information processing apparatus 1. In the present exemplary embodiment, a lighting effect is selected based on position information of an instruction object acquired through image-capturing using the in-camera 201, and the selected lighting effect is applied to a color image. In the present exemplary embodiment, the color image to which the lighting effect is to be applied is an image acquired by capturing an object of an image-capturing target (hereinafter, called as “object”) by the main-camera 202. In the present exemplary embodiment, a user's hand in a captured image acquired by the in-camera 201 is recognized as an instruction object. In the following description, an image acquired through image-capturing using the main-camera 202 is called a main-camera image, whereas an image acquired through image-capturing using the in-camera 201 is called as an in-camera image. The following processing will be started in a state where a color image and an icon that represents a lighting effect are displayed on the input/output unit 309.

In step S401, based on the user operation acquired from the input/output unit 309, the image data acquisition unit 301 acquires main-camera image data representing a main-camera image, distance image data, and normal line image data from the storage unit 307. In this case, the storage unit 307 has already stored main-camera image data, distance image data, and normal line image data previously generated through the above-described method. In step S402, based on the user operation acquired from the input/output unit 309, the lighting setting information acquisition unit 302 determines whether to apply a lighting effect to a main-camera image by using the lighting setting information. If an operation for using the lighting setting information is detected (YES in step S402), the processing proceeds to step S403. If the operation for using the lighting setting information is not detected (NO in step S402), the processing proceeds to step S404.

In step S403, based on the in-camera image data acquired through image-capturing using the in-camera 201, the lighting setting information acquisition unit 302 acquires position information indicating a position of an area corresponding to a user's hand (hereinafter, referred to as “hand area”) in the in-camera image. In the present exemplary embodiment, the position information of the hand area in the in-camera image is used as the lighting setting information. Details of processing for acquiring the lighting setting information will be described below. In step S404, the lighting effect setting unit 303 sets a lighting effect to be applied to the main-camera image based on the lighting setting information. Details of processing for setting the lighting effect will be described below.

In step S405, the lighting processing unit 304 corrects the main-camera image based on the set lighting effect. In the following description, the above-described corrected main-camera image is referred to as a corrected main-camera image, and image data representing the corrected main-camera image is referred to as corrected main-camera image data. Details of processing for correcting the main-camera image will be described below. In step S406, the image display control unit 305 displays the corrected main-camera image on the input/output unit 309. In step S407, the lighting effect display control unit 306 displays, on the input/output unit 309, an icon corresponding to the lighting effect applied to the main-camera image. In step S408, based on the user operation acquired by the input/output unit 309, the lighting processing unit 304 determines whether to store the corrected main-camera image data in the storage unit 307. If the operation for storing the corrected main-camera image data is detected (YES in step S408), the processing proceeds to step S410. If the operation for storing the corrected main-camera image is not detected (NO in step S408), the processing proceeds to step S409. In step S409, based on the user operation acquired from the input/output unit 309, the lighting processing unit 304 determines whether to change the main-camera image to which the lighting effect is to be applied. If the operation for changing the main-camera image is detected (YES in step S409), the processing proceeds to step S401. If the operation for changing the main-camera image is not detected (NO in step S409), the processing proceeds to step S402. In step S410, the lighting processing unit 304 stores the corrected main-camera image data in the storage unit 307 and ends the processing.

### <Processing for Acquiring Lighting Setting Information (S403)>

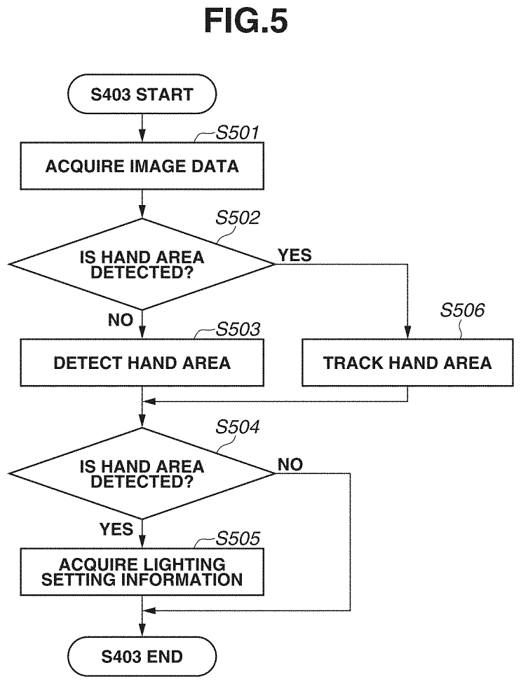

The processing for acquiring the lighting setting information executed in step S403 will be described. FIG. 5 is a flowchart illustrating the processing for acquiring the lighting setting information. The lighting setting information acquisition unit 302 detects a hand area corresponding to a user's hand as an instruction object in the in-camera image. The lighting setting information acquisition unit 302 acquires position information of the hand area detected from the in-camera image as the lighting setting information.

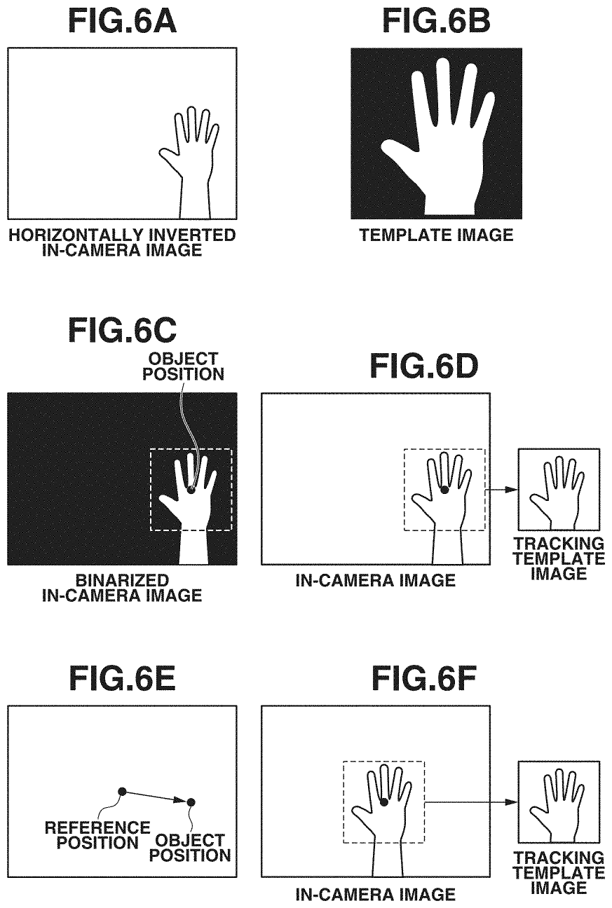

In step S501, the lighting setting information acquisition unit 302 acquires in-camera image data acquired by capturing the user's hand by the in-camera 201. In the present exemplary embodiment, the lighting setting information acquisition unit 302 horizontally inverts an in-camera image represented by the acquired in-camera image data, and uses the inverted in-camera image for the below-described processing. Thus, the in-camera image described below refers to the horizontally inverted in-camera image. An example of the in-camera image is illustrated in FIG. 6A. In step S502, the lighting setting information acquisition unit 302 determines whether a target object is detected in the in-camera image. More specifically, the lighting setting information acquisition unit 302 refers to a variable representing a state of the target object to make the determination. A state of the target object is either “undetected” or “detected”, and an undetected state is set as an initial state. In the present exemplary embodiment, the target object is the user's hand. If the user's hand is not detected (NO in step S502), the processing proceeds to step S503. If the user's hand is detected (YES in step S502), the processing proceeds to step S506.

In step S503, the lighting setting information acquisition unit 302 detects the instruction object from the in-camera image. As described above, the lighting setting information acquisition unit 302 detects a hand area corresponding to the user's hand in the in-camera image. A known method such as a template matching method or a method using a convolutional neural network (CNN) can be used for detecting the hand area. In the present exemplary embodiment, the hand area is detected in the in-camera image through the template matching method. First, the lighting setting information acquisition unit 302 extracts, as flesh-color pixels, pixels that can be regarded as pixels in flesh color, and extracts pixels other than the flesh-color pixels as background pixels. The flesh-color pixel is extracted based on whether the pixel value falls within a range of a predetermined value. The lighting setting information acquisition unit 302 generates binary image data representing a binary image by defining a flesh-color pixel as a pixel having a value of “1” and a background pixel as a pixel having a value of “0”. An example of the binary image data is illustrated in FIG. 6C. A binarized image of a silhouette of the hand is used as a template image. An example of the template image is illustrated in FIG. 6B. The lighting setting information acquisition unit 302 scans the binary image with the template image to derive the similarity. If a maximum similarity value is a predetermined value or more, a state of the hand area is determined to be “detected”. Further, coordinates on the in-camera image corresponding to the center of the template image, where the maximum similarity value is derived, are specified as a position of the hand area (object position). The lighting setting information acquisition unit 302 extracts a rectangular area that includes the silhouette of the hand when the template image is arranged on the object position from the in-camera image, and specifies the extracted rectangular area as a tracking template image. An example of a tracking template image is illustrated in FIG. 6D. In addition, a state of the hand area is determined to be “undetected” if the maximum similarity value is less than the predetermined value.

In step S504, the lighting setting information acquisition unit 302 determines whether the hand area is detected. If the hand area is detected (YES in step S504), the processing proceeds to step S505. If the hand area is not detected (NO in step S504), the processing in step S403 is ended. In step S505, the lighting setting information acquisition unit 302 acquires the lighting setting information based on the object position. In the present exemplary embodiment, a vector directed to the object position from a reference position is specified as a position information of the hand area, and this position information is acquired as the lighting setting information. A vector directed to the object position from the reference position is illustrated in FIG. 6E. The center of the in-camera image is specified as the reference position.

In step S506, based on the tracking template image, the lighting setting information acquisition unit 302 tracks the hand area. In this case, the lighting setting information acquisition unit 302 scans the stored tracking template image with respect to the in-camera image to derive the similarity. If a maximum similarity value is a predetermined value or more, a state of the hand area is determined to be “detected”. Further, coordinates on the in-camera image corresponding to the center of the template image, where the maximum similarity value is derived, is determined as a position of the hand area. The lighting setting information acquisition unit 302 extracts a rectangular area corresponding to the tracking template image from the in-camera image, and sets the extracted rectangular area as a new tracking template image. The updated tracking template image is illustrated in FIG. 6E Further, if the maximum similarity value is less than the predetermined value, a state of the hand area is determined to be “undetected”.

### <Processing for Setting Lighting Effect (S404)>

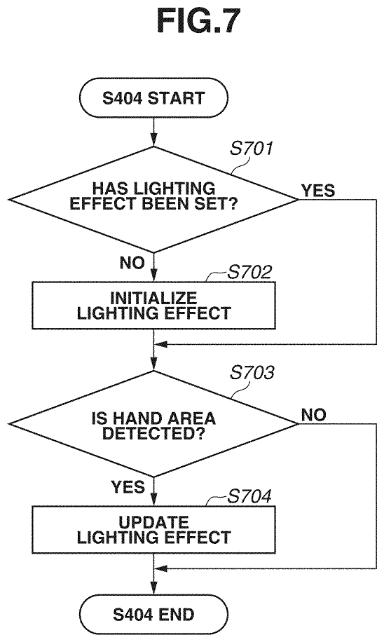

The processing for setting the lighting effect executed in step S404 will be described. FIG. 7 is a flowchart illustrating the processing for setting the lighting effect. Based on the acquired lighting setting information, the lighting effect setting unit 303 selects one lighting effect from among a plurality of lighting effects.

In step S701, the lighting effect setting unit 303 determines whether the lighting effect is set. If the lighting effect is not set (NO in step S701), the processing proceeds to step S702. If the lighting effect is set (YES in step S701), the processing proceeds to step S703. In step S702, the lighting effect setting unit 303 initializes the set lighting effect. In the present exemplary embodiment, the lighting effect is set to “OFF”. In step S703, the lighting effect setting unit 303 determines whether the hand area is detected. If the hand area is detected (YES in step S703), the processing proceeds to step S704. If the hand area is not detected (NO in step S703), the processing in step S404 is ended.

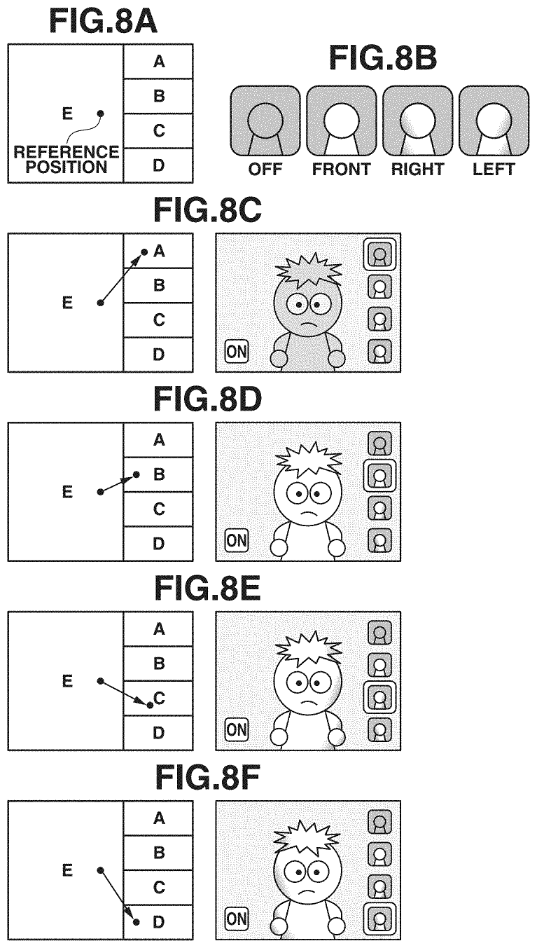

In step S704, based on the lighting setting information, the lighting effect setting unit 303 updates a setting of the lighting effect. In the present exemplary embodiment, a vector directed to the object position from the reference position, which is the lighting setting information, is classified into any one of five patterns. A classification method of the vector is illustrated in FIG. 8A. In FIG. 8A, the center of the in-camera image is set as a reference position, and five areas A, B, C, D, and E are set. A setting of the lighting effect is updated according to the area away from the reference position by an amount of the vector. In the present exemplary embodiment, four types of settings, i.e., “OFF”, “FRONT”, “LEFT” and “RIGHT” are provided as the settings of the lighting effect. The lighting effect is not applied when the setting is “OFF”, and the lighting effect provided by a virtual light source arranged in front of the object is applied when the setting is “FRONT”. The lighting effect provided by a virtual light source arranged on the left side of the main-camera image (i.e., the right side of the object) is applied when the setting is “LEFT”. The lighting effect provided by a virtual light source arranged on the right side of the main-camera image (i.e., the left side of the object) is applied when the setting is “RIGHT”. The lighting effect setting unit 303 updates the setting to “OFF” when the vector that represents the position of the hand area is directed to the area A. The setting is updated to “FRONT” when the vector is directed to the area B. The setting is updated to “LEFT” when the vector is directed to the area C. The setting is updated to “RIGHT” when the vector is directed to the area D. The setting is not updated when the vector is directed to the area E. An example of an icon that represents each lighting effect is illustrated in FIG. 8B.

### <Processing for Correcting Main-Camera Image (S405)>

The processing for correcting the main-camera image executed in step S405 will be described. The lighting processing unit 304 applies the lighting effect to the main-camera image by correcting the main-camera image based on the distance image data and the normal line image data. By switching a parameter according to the set lighting effect, the lighting effect can be applied to the main-camera image as if light is emitted from a desired direction through the same processing procedure. Hereinafter, a specific example of the processing procedure will be described. First, brightness of the background of the main-camera image is corrected according to the equation (1). A pixel value of the main-camera image is expressed as “I”, and a pixel value of the main-camera image after making a correction on the brightness of the background is expressed as “I′”.

I′=(1−β)I+βD(d)I (1)

In the equation (1), “β” is a parameter for adjusting the darkness of the background, and “D” is a function based on a pixel value (distance value) “d” of the distance image. A value acquired by the function D is smaller as the distance value d is greater, and the value falls within a range of 0 to 1. Thus, the function D returns a greater value with respect to a distance value that represents a foreground, and returns a smaller value with respect to a distance value that represents a background. A value from 0 to 1 is set to the parameter β, and the background of the main-camera image is corrected to be darker when the parameter β is closer to 1. By executing correction according to the equation (1), a pixel can be darkened corresponding to the parameter β only when the distance value d is large and the value of the function D is less than 1.

Next, a shadow corresponding to the distance image data and the normal line image data is added, according to the equation (2), to the main-camera image after the brightness of the background is corrected. A pixel value of the shaded main-camera image is expressed as “I″”.

I″=I′+αD(d)H(n,L)I′ (2)

In the equation (2), “α” is a parameter for adjusting the brightness of the light source, and “L” is a light source vector that represents a direction from the object to the virtual light source. Further, “H” is a function based on a pixel value (normal vector) “n” of the normal line image and the light source vector L. A value acquired by the function H is greater when an angle formed by the normal vector “n” and the light source vector L is smaller, and the value falls within a range of 0 to 1. For example, the function H can be set as the equation (3).

$$H = \{ \begin{matrix}n \cdot L & n \cdot L \geq O \\ O & otherwise\end{matrix} \qquad ( 3 )$$

In the present exemplary embodiment, the lighting processing unit 304 switches the parameters depending on the set lighting effect. When the lighting effect is set to “OFF”, both of the parameters “α” and “β” are 0 (α=0, β=0). When the lighting effect is set to “FRONT”, the light source vector L is set to the front direction with respect to the object. When the lighting effect is set to “LEFT”, the light source vector L is set to the left direction with respect to the main-camera image (i.e., the right direction with respect to the object). When the lighting effect is set to “RIGHT”, the light source vector L is set to the right direction with respect to the main-camera image (i.e., the left direction with respect to the object).

Examples of the lighting setting information and display images when the respective lighting effects are selected are illustrated in FIGS. 8C to 8F. FIG. 8C illustrates the lighting setting information and the display image when the lighting effect is set to “OFF”. FIG. 8D illustrates the lighting setting information and the display image when the lighting effect is set to “FRONT”. FIG. 8E illustrates the lighting setting information and the display image when the lighting effect is set to “LEFT”. FIG. 8F illustrates the lighting setting information and the display image when the lighting effect is set to “RIGHT”. The display image is an image including a corrected main-camera image displayed in step S406 and an icon representing the lighting effect displayed in step S407. The icons representing the respective lighting effects are displayed on the right side of the display image. Further, a button that allows a user to determine whether to use the lighting setting information is displayed on the lower left portion of the display image. In step S402, the lighting setting information acquisition unit 302 determines whether to use the lighting setting information based on the user operation executed on the button.

### Effect of the First Exemplary Embodiment

As described above, the information processing apparatus according to the present exemplary embodiment acquires image data representing an image and acquires position information of the instruction object for adjusting a lighting effect applied to the image. The lighting effect applied to the image is set based on the position information. In this way, the lighting effect can be applied to the image through a simple operation such as moving the instruction object such as a hand or a face within an image-capturing range.

### Modification Example

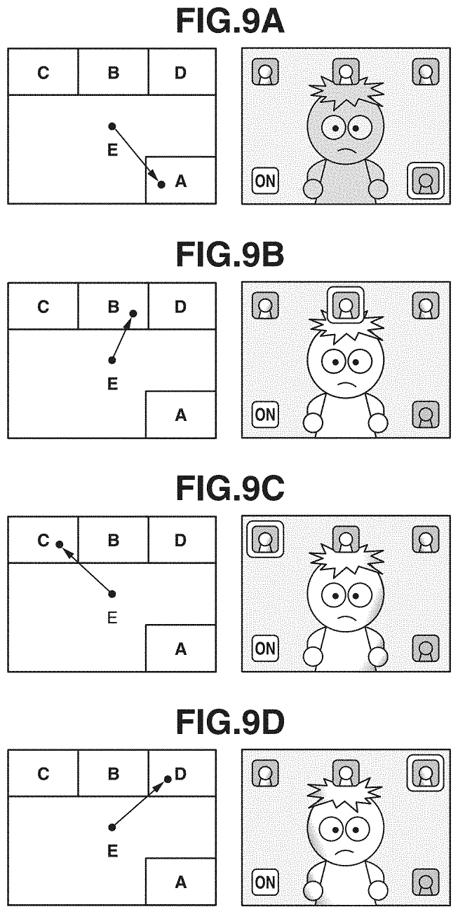

As illustrated in FIGS. 8A to 8F, in the present exemplary embodiment, the areas A, B, C, and D are arranged in the vertical direction, and the vector is classified. However, a method of classifying the vector is not limited to the above-described example. For example, as illustrated in FIGS. 9A to 9D, each of the areas A to D may be set to conform to a direction of the light source vector corresponding to each lighting effect. In the examples illustrated in FIGS. 9A to 9D, the area C corresponding to the lighting effect “LEFT” is arranged on the upper left portion, the area B corresponding to the lighting effect “FRONT” is arranged on the upper middle portion, and the area D corresponding to the lighting effect “RIGHT” is arranged on the upper right portion. By setting the areas A to D as described above, a moving direction of the hand conforms to the direction of the light source vector (position of the light source), so that the user can set the lighting effect more intuitively.

Further, in the present exemplary embodiment, although the lighting effect is selected based on the position information of the hand area in the in-camera image, a direction of a light source vector L may be derived based on the position information of the hand area in the in-camera image. One example of the method of deriving a direction of the light source vector L based on the position information of the hand area will be described. First, based on a vector S=(u_{S}, v_{S}) directed to the object position from the reference position in the in-camera image, the lighting effect setting unit 303 derives a latitude θ and a longitude φ of a light source position according to the equation (4).

$$ϕ = \{ \begin{matrix}- {ϕ}_{max} & ( {u}_{s} \leq - U ) \\ \frac{{u}_{s}}{U} {ϕ}_{max} & ( U < {u}_{s} N < U ) \\ {ϕ}_{max} & ( U < {u}_{x} )\end{matrix} \\ θ = \{ \begin{matrix}{θ}_{max} & ( {υ}_{s} < V ) \\ \frac{{v}_{s}}{V} {θ}_{max} & ( - V < {v}_{s} \leq V ) \\ {θ}_{max} & ( V < {v}_{x} )\end{matrix} \qquad ( 4 )$$

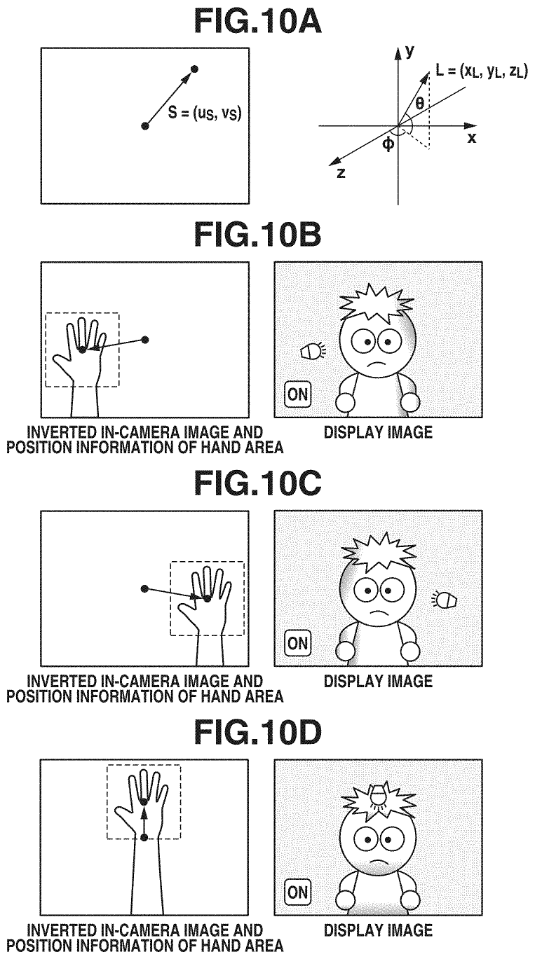

In the equation (4), “φₘₐₓ” is a maximum settable longitude, whereas “θₘₐₓ” is a maximum settable latitude. “U” is a moving amount in a horizontal direction that makes the longitude be the maximum settable longitude φₘₐₓ, and “V” is a moving amount in a vertical direction that makes the latitude be the maximum settable latitude θₘₐₓ. The respective moving amounts U and V may be set based on the size of the in-camera image. Further, the latitude θ and the longitude φ of the light source position is to follow the examples illustrated in FIG. 10A. In FIG. 10A, a positive direction of a z-axis is the front direction, a positive direction of an x-axis is the right direction of the main-camera image, and a positive direction of a y-axis is the upper direction of the main-camera image.

Next, based on the latitude θ and the longitude φ, the lighting effect setting unit 303 derives the light source vector L=(x_{L}, y_{L}, z_{L}) according to the equation (5).

x_{L}=cos θ sin φ

y_{L}=sin θ

z_{L}=cos θ cos φ (5)

As described above, by setting the light source vector L based on the movement of the hand, a position of the light source can be changed based on the movement of the hand. FIGS. 10B to 10D are diagrams illustrating an example of the position information of the hand area and the display image when a position of the light source is changed according to the movement of the hand. FIG. 10B illustrates the position information of the hand area and an example of the display image when the hand is moved in the left direction with respect to the in-camera. FIG. 10C illustrates an example of the position information of the hand area and the display image when the hand is moved in the right direction facing the in-camera. FIG. 10D illustrates an example of the position information of the hand area and the display image when the hand is moved in the upper direction facing the in-camera. In this case, an icon representing the light source is displayed on the display image, and the display position or the orientation of the icon is changed depending on the light source vector L.

Although the latitude θ and the longitude φ of the light source position are derived to be proportional to the respective components (u_{S}, v_{S}) of the vector S based on the equation (4), a derivation method of the latitude θ and the longitude φ is not limited to the above-described example. For example, changing amounts of the latitude θ and the longitude φ of the light source position may be smaller as the absolute values of the components u_{S} and v_{S} are greater. In this way, an amount of change in a direction of the light source vector with respect to the movement of the hand is greater when a direction of the light source vector is close to the front direction, and an amount of change in a direction of the light source vector with respect to the movement of the hand is smaller as a direction of the light source vector is far from the front direction. When a direction of the light source vector is close to the front direction, there may be a case where an amount of change in impression of the object caused by the change in a direction of the light source vector is small. By controlling the direction of the light source vector as described above, it is possible to equalize the amount of change in the impression of the object with respect to the movement of the hand.

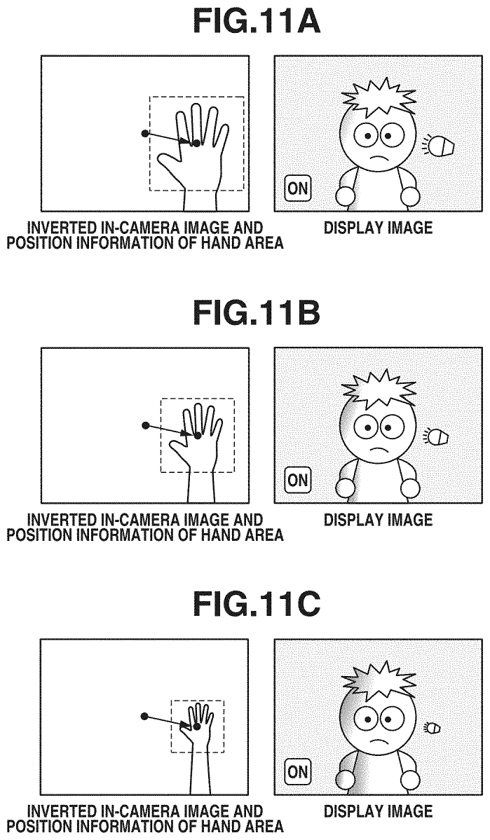

Further, in the present exemplary embodiment, a parameter used for applying the lighting effect is set based on the position information of the hand area in the in-camera image. However, the parameter may be set based on a size of the hand area in the in-camera image. For example, in step S503 or S506, a size of the tracking template image is acquired as a size of the hand area. In the processing for correcting the main-camera image, the parameter α for adjusting the brightness of the light source is set based on the size of the hand area. For example, the parameter α may be set to be greater as the hand area is larger. FIGS. 11A to 11C are diagrams illustrating examples of position information of the hand area and the display image when the parameter is controlled based on the size of the hand area. A size of the hand area in FIG. 11A is the largest, and the a size thereof becomes smaller in the order of FIGS. 11B and 11C. At this time, a size of the icon representing a light source is changed based on the value of the parameter α.

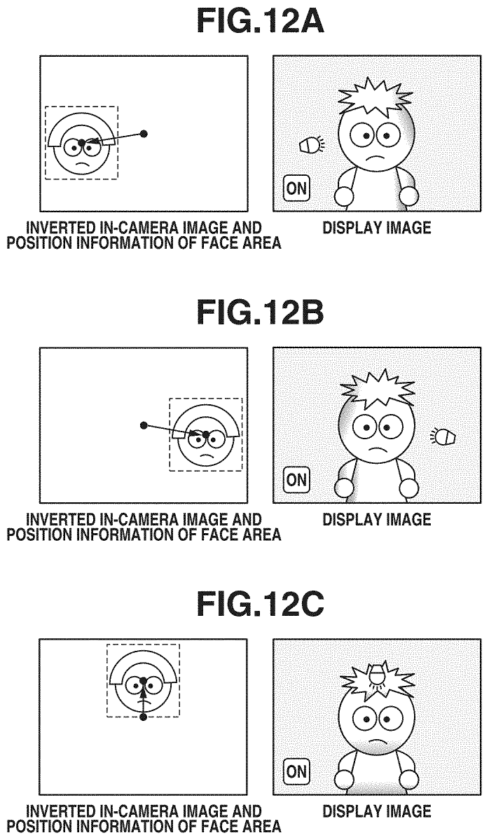

Further, in the present exemplary embodiment, a user's hand is used as an instruction object moved for setting the lighting effect. However, another object existing in a real space can be also used as the instruction object. For example, a user's face may be used as the instruction object. In this case, a face area is detected in an in-camera image instead of a hand area, and position information of the face area in the in-camera image is acquired as the lighting setting information. In step S503, the lighting setting information acquisition unit 302 detects the face area in the in-camera image. A known method such as a template matching method or algorithm using the Haar-Like feature amount can be used for detecting the face area. FIGS. 12A to 12C are diagrams illustrating examples of position information of the face area and a display image when a direction of the light source vector is changed based on the face area. Further, an object held by the user can be also used as the instruction object instead of the hand or the face.

Further, in the present exemplary embodiment, the lighting setting information is acquired based on the in-camera image data. However, an acquisition method of the lighting setting information is not limited thereto. For example, a camera capable of acquiring the distance information is arranged on a same face as the touch-panel display 105, and movement information of the object that can be acquired from the distance information acquired by the camera may be acquired as the lighting setting information.

Further, in the present exemplary embodiment, although position information of the instruction object in the in-camera image is acquired as the lighting setting information, three-dimensional position information of the instruction object in a real space may be acquired as the lighting setting information. For example, distance (depth) information of the instruction object in a real space can be acquired by the in-camera. A known method such as a method of projecting a pattern on the object can be used as the acquisition method of the distance (depth) information.

In the first exemplary embodiment, the lighting effect is set based on the position information of the hand area. In a second exemplary embodiment, the lighting effect is set based on orientation information indicating orientation of the touch-panel display 105. In addition, a hardware configuration and a logical configuration of the information processing apparatus 1 of the present exemplary embodiment are similar to those described in the first exemplary embodiment, so that description thereof will be omitted. In the following description, portions different from the first exemplary embodiment will be mainly described. Further, the same reference numerals will be applied to the constituent elements similar to those of the first exemplary embodiment.

### <Processing Executed by Information Processing Apparatus 1>

The present exemplary embodiment is different from the first exemplary embodiment in the processing for acquiring the lighting setting information in step S403 and the processing for setting the lighting effect in step S404. The lighting setting information acquisition unit 302 of the present exemplary embodiment acquires orientation information of the touch-panel display 105 as the lighting setting information. The lighting effect setting unit 303 in the present exemplary embodiment sets a lighting effect based on the orientation information of the touch-panel display 105. In the following description, the processing for acquiring the lighting setting information and the processing for setting the lighting effect will be described in detail.

### <Processing for Acquiring Lighting Setting Information (S403)>

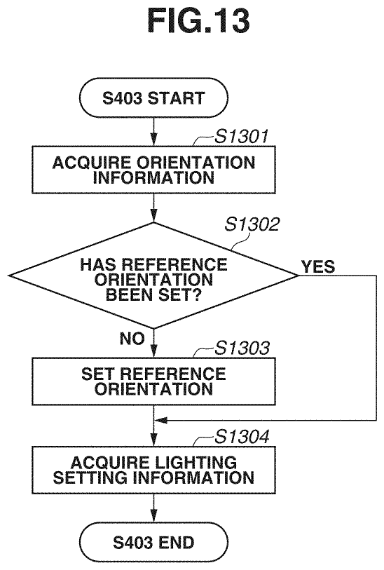

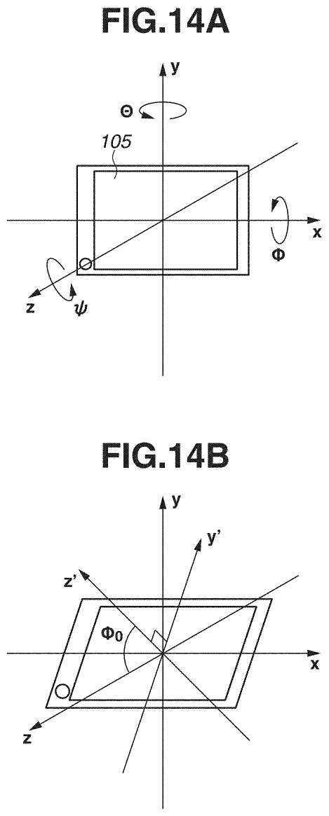

FIG. 13 is a flowchart illustrating the processing for acquiring the lighting setting information. In step S1301, the lighting setting information acquisition unit 302 acquires orientation information of the touch-panel display 105 from the orientation acquisition unit 108. In the present exemplary embodiment, rotation angles around respective axes in a horizontal direction (x-axis), a vertical direction (y-axis) and a perpendicular direction (z-axis) perpendicular to the touch-panel display 105, when the touch-panel display 105 is held in a state where a lengthwise side thereof is placed horizontally, are used as the orientation information. The rotation angles used as the orientation information are illustrated in FIG. 14A. In FIG. 14A, an x-axis rotation angle (yaw angle) is expressed as “Φ”, a y-axis rotation angle (pitch angle) is expressed as “Θ”, and a z-axis rotation angle (roll angle) is expressed as “Ψ”.

In step S1302, the lighting setting information acquisition unit 302 determines whether a reference orientation has been set. If the reference orientation has not been set (NO in step S1302), the processing proceeds to step S1303. If the reference orientation has been set (YES in step S1302), the processing proceeds to step S1304. In step S1303, the lighting setting information acquisition unit 302 sets the reference orientation. Specifically, a pitch angle Θ indicated by the acquired orientation information is set as a reference pitch angle Θ₀.

In step S1304, the lighting setting information acquisition unit 302 acquires the lighting setting information based on the orientation information. Specifically, based on the pitch angle Θ and the yaw angle Φ, orientation setting information Θ′ and Φ′ are derived according to the equation (6).

Θ′=Θ−Θ₀

Φ′=Φ (6)

The orientation setting information Θ′ and Φ′ respectively represent changing amounts of the pitch angle and the yaw angle with respect to the reference orientation. In other words, in the present exemplary embodiment, the lighting setting information is information indicating an inclination direction and an inclination degree of the touch-panel display 105. In addition, in step S1303, the reference yaw angle Φ₀ may be set as the reference orientation. In the example illustrated in FIG. 14B, a reference yaw angle Φ₀ is set as a reference orientation. In this case, orientation setting information Θ′ and Φ′ are derived according to the equation (7).

Θ′=Θ−Φ₀

Φ′=Φ−Φ₀ (7)

By setting the reference orientation as described above, the orientation in which the user can easily look at or listen to the touch-panel display 105 can be set as the reference orientation.

### <Processing for Setting Lighting Effect (S404)>

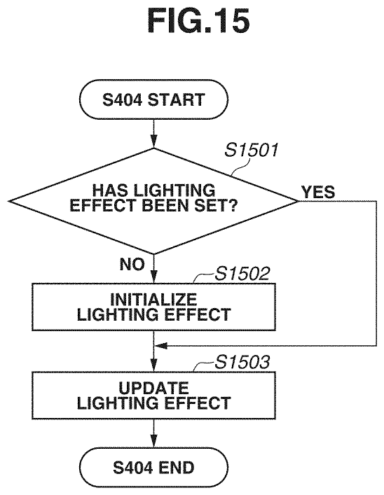

FIG. 15 is a flowchart illustrating the processing for setting the lighting effect. In step S1501, the lighting effect setting unit 303 determines whether the lighting effect has been set. If the lighting effect has not been set (NO in step S1501), the processing proceeds to step S1502. If the lighting effect has been set (YES in step S1501), the processing proceeds to step S1503. In step S1502, the lighting effect setting unit 303 initializes a setting of the lighting effect. In the present exemplary embodiment, a direction of the light source vector is a front direction (the latitude θ and the longitude φ of the light source position are 0 (θ=0, φ=0)).

In step S1503, the lighting effect setting unit 303 updates the setting of the lighting effect based on the lighting setting information. In the present exemplary embodiment, the lighting effect setting unit 303 derives the latitude θ and the longitude φ of the light source position according to the equation (8) based on the orientation setting information Θ′ and Φ′.

$$θ = \{ \begin{matrix}- {θ}_{max} & ( {α}_{θ} {Θ}^{′} \leq - {θ}_{max} ) \\ {α}_{θ} {Θ}^{′} & ( - {θ}_{max} < {α}_{θ} {Θ}^{′} \leq {θ}_{max} ) \\ {θ}_{max} & ( {θ}_{max} < {α}_{θ} {Θ}^{′} )\end{matrix} \\ ϕ = \{ \begin{matrix}- {ϕ}_{max} & ( {α}_{Φ} {φ}^{′} \leq - {ϕ}_{max} ) \\ {α}_{Φ} {φ}^{′} & ( - {ϕ}_{max} < {α}_{Φ} {φ}^{′} < {ϕ}_{max} ) \\ {ϕ}_{max} & ( {ϕ}_{max} < {α}_{Φ} {φ}^{′} )\end{matrix} \qquad ( 8 )$$

In the above equation (8), “θₘₐₓ” is a maximum settable latitude, whereas “φₘₐₓ” is a maximum settable longitude. A coefficient for the orientation setting information Θ′ is expressed as “α_{Θ}”, and a coefficient for the orientation setting information Φ′ is expressed as “α_{Φ}”. By increasing the absolute values of the coefficients α_{Θ} and α_{Φ}, a changing amount of a direction of the light source vector with respect to the inclination of the touch-panel display 105 becomes greater. Further, the latitude θ and the longitude φ of the light source position are as illustrated in FIG. 10A. Next, based on the latitude θ and the longitude φ, the lighting effect setting unit 303 derives the light source vector L=(x_{L}, y_{L}, z_{L}) according to the equation (5).

### Effect of the Second Exemplary Embodiment

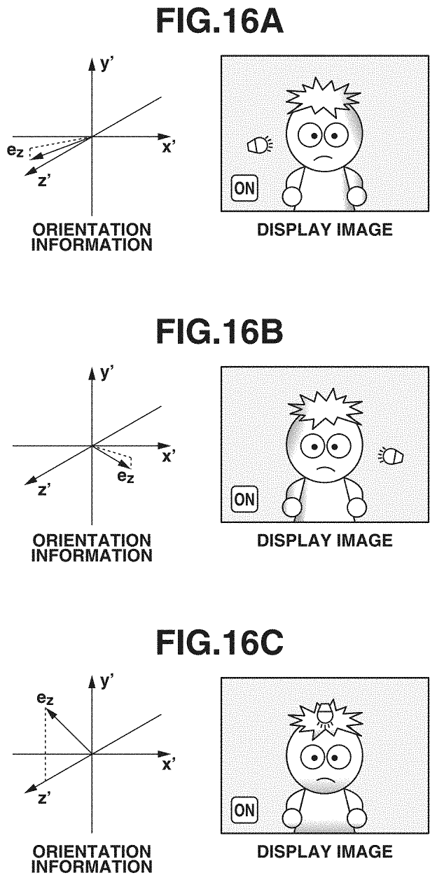

As described above, the information processing apparatus 1 according to the present exemplary embodiment sets a position of the virtual light source for lighting the object based on the orientation information of the touch-panel display 105. In this way, the lighting effect can be applied to the image through a simple operation of inclining the touch-panel display 105. FIGS. 16A to 16C are diagrams illustrating the orientation information and examples of a display image when a direction of the light source vector is changed. FIG. 16A illustrates the orientation information and an example of a display image when the touch-panel display 105 is inclined in the left direction. FIG. 16B illustrates the orientation information and an example of a display image when the touch-panel display 105 is inclined in the right direction. FIG. 16C illustrates the orientation information and an example of a display image when the touch-panel display 105 is inclined in the upper direction. In these examples, an icon representing a light source is displayed on the display image, and the display position and the orientation of the icon are changed depending on the light source vector L.

### Modification Example

In the present exemplary embodiment, the latitude θ and the longitude φ of the light source position are derived so as to be proportional to the orientation setting information Θ′ and Φ′ according to the equation (8). However, a derivation method of the latitude θ and the longitude φ is not limited to the above-described example. For example, changing amounts of the latitude θ and the longitude φ of the light source position may be smaller as the absolute values of the orientation setting information Θ′ and Φ′ are greater. In this way, an amount of change in a direction of the light source vector with respect to the inclination of the touch-panel display 105 is greater as a direction of the light source vector is close to the front direction, and an amount of change in a direction of the light source vector with respect to the inclination of the touch-panel display 105 is smaller as a direction of the light source vector is far from the front direction. When a direction of the light source vector is close to the front direction, there is a case where an amount of change in the impression of the object caused by the change in a direction of the light source vector is small. By controlling the direction of the light source vector as described above, it is possible to level a change in the impression of the object with respect to the inclination of the touch-panel display 105.

Further, in FIGS. 16A to 16C of the present exemplary embodiment, examples of a display image when the coefficients α_{Θ} and α_{Φ} have positive values are illustrated. However, the coefficients α_{Θ} and α_{Φ} may have negative values. In this case, a position of the light source can be set in an opposite direction with respect to the orientation of the touch-panel display 105. For example, the light source is moved to the right when the touch-panel display 105 is inclined to the left, and the light source is moved downward when the touch-panel display 105 is inclined upward. In this way, the user can intuitively find out the position of the light source.

Further, similar to the case of the first exemplary embodiment, the lighting effect may be selected depending on the orientation information. In this case, firstly, the vector S=(u_{S}, v_{S}) is derived based on the orientation setting information Θ′ and Φ′. For example, the component u_{S} is derived based on the orientation setting information Φ′, and the component v_{S} is derived based on the orientation setting information Θ′.

In the first exemplary embodiment, the lighting effect is set based on the position information of the hand area. In the second exemplary embodiment, the lighting effect is set based on the orientation information of the touch-panel display 105. In a third exemplary embodiment, the lighting effect is set based on the information indicating a size of the hand area and the orientation information of the touch-panel display 105. Further, a hardware configuration and a logical configuration of the information processing apparatus 1 according to the present exemplary embodiment are similar to those described according to the first exemplary embodiment, so that description thereof will be omitted. In the following description, portions different from those of the first exemplary embodiment will be mainly described. Further, the same reference numerals will be applied to the constituent elements similar to those of the first exemplary embodiment.

### <Processing Executed by Information Processing Apparatus 1>

The present exemplary embodiment is different from the first exemplary embodiment in the processing for acquiring the lighting setting information in step S403 and the processing for setting the lighting effect in step S404. The lighting setting information acquisition unit 302 of the present exemplary embodiment acquires the information indicating a size of the hand area in the in-camera image and the orientation information of the touch-panel display 105 as the lighting setting information. The lighting effect setting unit 303 according to the present exemplary embodiment sets the lighting effect based on the information indicating a size of the hand area in the in-camera image and the orientation information of the touch-panel display 105. In the following description, the processing for acquiring the lighting setting information and the processing for setting the lighting effect will be described in detail.

### <Processing for Acquiring Lighting Setting Information (S403)>

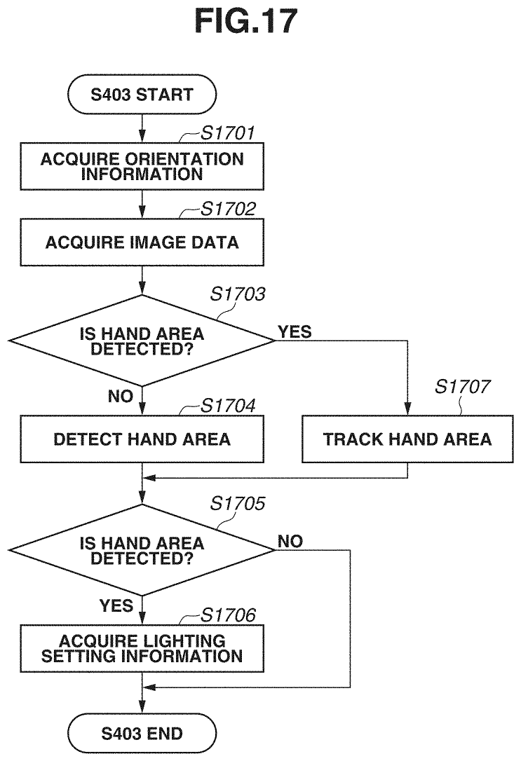

FIG. 17 is a flowchart illustrating the processing for acquiring the lighting setting information. The processing in step S1701 is similar to the processing in step S1301 of the second exemplary embodiment, so that description thereof will be omitted. Further, the processing in steps S1702, S1703, S1705, and S1707 are similar to the processing in steps S501, S502, S504, and S506 in the first exemplary embodiment, so that description thereof will be omitted.

In step S1704, the lighting setting information acquisition unit 302 detects an instruction object in the in-camera image. A detection method is similar to the method described in the first exemplary embodiment. Further, the lighting setting information acquisition unit 302 acquires a size of the tracking template image as a size of the hand area. In step S1706, the lighting setting information acquisition unit 302 acquires the information indicating the size of the hand area in the in-camera image and the orientation information of the touch-panel display 105 as the lighting setting information.

### <Processing for Setting Lighting Effect (S404)>

The processing in step S404 of the present exemplary embodiment is different from the processing in step S404 of the first exemplary embodiment in the processing for updating the lighting effect executed in step S704. In the following description, the processing for updating the lighting effect executed in step S704 of the present exemplary embodiment will be described. In step S704, based on the orientation setting information Θ′ and Φ′, the lighting processing unit 304 sets a direction of the light source vector L, and sets the parameter α for adjusting the brightness of the light source based on the information indicating the size of the hand area in the in-camera image. A setting method of the direction of the light source vector L is similar to the method described in the second exemplary embodiment. Further, the parameter α for adjusting the brightness of the light source is set to be greater as the hand area is larger.

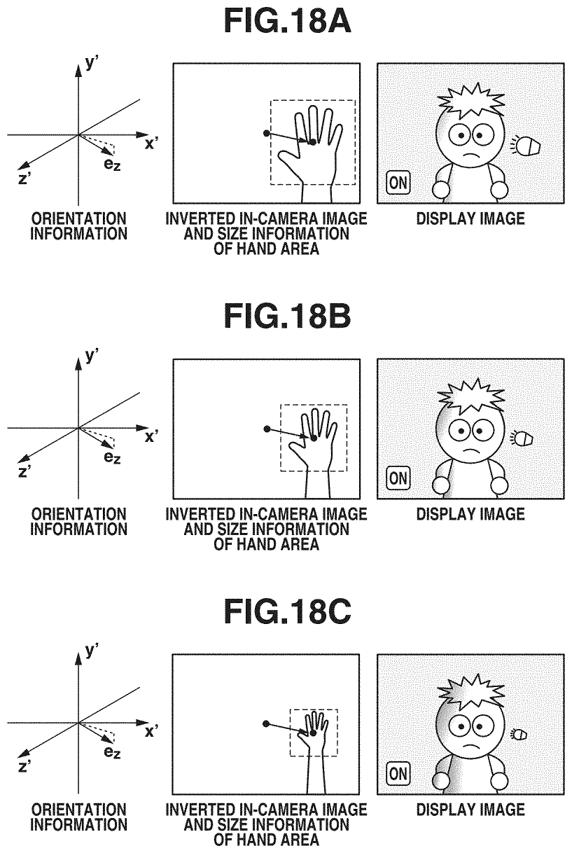

FIGS. 18A to 18C are diagrams illustrating the lighting setting information and examples of a display image when the information indicating a size of the hand area in the in-camera image and the orientation information of the touch-panel display 105 are set as the lighting setting information. In these examples, the lighting setting information and examples of a display image when a size of the hand area is changed in a state where the touch-panel display 105 is inclined in the right direction are illustrated. A size of the hand area is the largest in FIG. 18A, and a size thereof becomes smaller in the order of FIGS. 18B and 18C. In FIGS. 18A to 18C, a size of the icon representing a light source is changed based on the value of the parameter α.

### Effect of the Third Exemplary Embodiment

As described above, the information processing apparatus 1 according to the present exemplary embodiment sets the lighting effect based on the size information of the hand area and the orientation information of the touch-panel display 105. In this way, the lighting effect can be applied to the image through a simple operation.

In the above-described exemplary embodiments, the lighting effect is applied to the main-camera image represented by the main-camera image data previously generated and stored in the storage apparatus 111. In a fourth exemplary embodiment, the lighting effect is applied to an image represented by image data acquired through image-capturing processing using the image-capturing unit 106. Further, a hardware configuration and a logical configuration of the information processing apparatus 1 according to the present exemplary embodiment are similar to those described in the first exemplary embodiment, so that description thereof will be omitted. In the following description, portions different from those of the first exemplary embodiment will be mainly described. Further, the same reference numerals will be applied to the constituent elements similar to those of the first exemplary embodiment.

### <Processing Executed by Information Processing Apparatus 1>

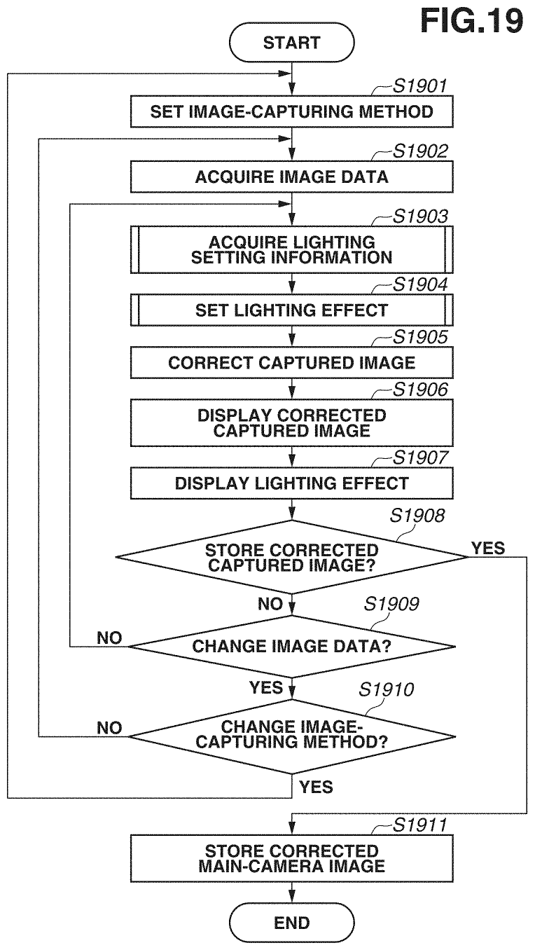

FIG. 19 is a flowchart illustrating processing executed by the information processing apparatus 1 according to the present exemplary embodiment. In step S1901, based on the user operation acquired by the input/output unit 309, the image data acquisition unit 301 sets an image-capturing method for acquiring image data. More specifically, the image data acquisition unit 301 selects whether to capture an object by using the in-camera 201 disposed on a display face of the information processing apparatus 1 or the main-camera 202 disposed on a back face of the information processing apparatus 1.

In step S1902, the image data acquisition unit 301 controls the selected camera to capture the object and acquires captured image data through the image-capturing. Further, the image data acquisition unit 301 acquires distance image data and normal line image data corresponding to the captured image data. In step S1903, based on in-camera image data newly captured and acquired by the in-camera 201, the lighting setting information acquisition unit 302 acquires position information of the hand area in the in-camera image. In step S1904, the lighting effect setting unit 303 sets the lighting effect based on the lighting setting information acquired from the lighting setting information acquisition unit 302.

In step S1905, the lighting processing unit 304 corrects the captured image represented by the captured image data based on the set lighting effect. Hereinafter, the captured image corrected through the above processing is referred to as a corrected captured image, and image data representing the corrected captured image is referred to as corrected captured image data. In step S1906, the image display control unit 305 displays the corrected captured image on the input/output unit 309. In step S1907, the lighting effect display control unit 306 displays an icon corresponding to the lighting effect applied to the captured image on the input/output unit 309.

In step S1908, based on the user operation acquired by the input/output unit 309, the lighting processing unit 304 determines whether to store the corrected captured image data in the storage unit 307. If the operation for storing the corrected captured image data is detected (YES in step S1908), the processing proceeds to step S1911. If the operation for storing the corrected captured image data is not detected (NO in step S1908), the processing proceeds to step S1909. In step S1909, based on the user operation acquired by the input/output unit 309, the lighting processing unit 304 determines whether to change the captured image to which the lighting effect is to be applied. If the operation for changing the captured image is detected (YES in step S1909), the processing proceeds to step S1910. If the operation for changing the captured image is not detected (NO in step S1909), the processing proceeds to step S1903. In step S1910, based on the user operation acquired by the input/output unit 309, the lighting processing unit 304 determines whether to change the image-capturing method for acquiring the captured image. If the operation for changing the image-capturing method is detected (YES in step S1910), the processing proceeds to step S1901. If the operation for changing the image-capturing method is not detected (NO in step S1910), the processing proceeds to step S1902. In step S1911, the lighting processing unit 304 stores the corrected captured image data in the storage unit 307 and ends the processing.

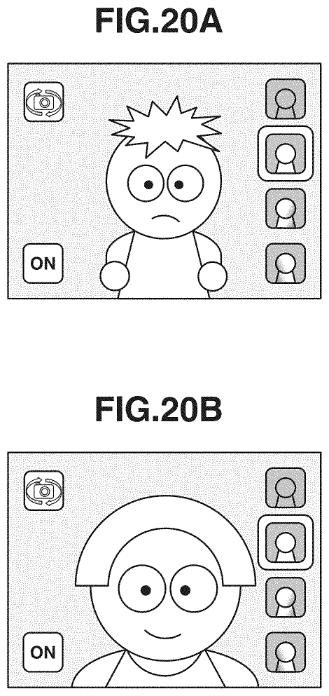

Examples of a display image in the present exemplary embodiment are illustrated in FIGS. 20A and 20B. FIG. 20A is a diagram illustrating an example of a display image when image-capturing using the main-camera 202 is selected as the image-capturing method. FIG. 20B is a diagram illustrating an example of a display image when image-capturing using the in-camera 201 is selected as the image-capturing method. In the present exemplary embodiment, the user switches the image-capturing method by touching an icon displayed on the upper left portion of the display image.

### Effect of the Fourth Exemplary Embodiment

As described above, the information processing apparatus 1 according to the present exemplary embodiment acquires image data representing a target image to which the lighting effect is to be applied through the image-capturing method set by the user operation. In this way, the lighting effect can be applied to the image through a simple operation.

### Modification Example

In the above-described exemplary embodiments, the information processing apparatus 1 includes the hardware configuration as illustrated in FIG. 1A. However, the hardware configuration of the information processing apparatus 1 is not limited thereto. For example, the information processing apparatus 1 may include a hardware configuration illustrated in FIG. 1B. The information processing apparatus 1 includes a CPU 101, a ROM 102, a RAM 103, a video card (VC) 121, a universal I/F 114, and a serial advanced technology attachment (SATA) I/F 119. The CPU 101 uses the RAM 103 as a work memory to execute an OS and various programs stored in the ROM 102 and a storage apparatus 111. Further, the CPU 101 controls respective constituent elements via a system bus 109. Input devices 116 such as a mouse and a keyboard, an image-capturing apparatus 117, and an orientation acquisition apparatus 118 are connected to the universal I/F 114 via a serial bus 115. The storage apparatus 111 is connected to the SATA I/F 119 via a serial bus 120. A display 113 is connected to the VC 121 via a serial bus 112. The CPU 101 displays a user interface (UI) provided by a program on the display 113, and receives input information indicating a user instruction acquired via the input device 116. For example, the information processing apparatus 1 illustrated in FIG. 1B can be implemented by a desk-top PC. In addition, the information processing apparatus 1 can be implemented by a digital camera integrated with the image-capturing apparatus 117 or a PC integrated with the display 113.

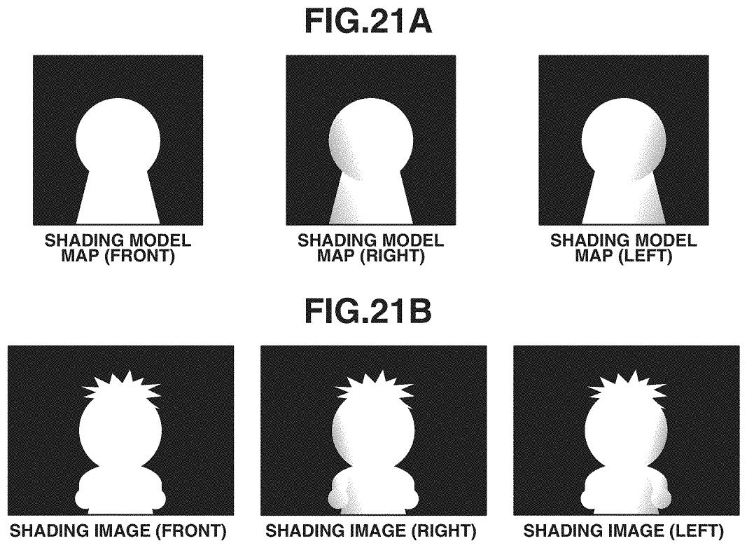

Further, in the above-described exemplary embodiments, when the lighting effect is applied to the image, information relating to a shape of the object (i.e., distance image data and normal line image data) is used. However, the lighting effect may be applied to the image by using another data. For example, a plurality of shading model maps corresponding to the lighting effects, as illustrated in FIG. 21A, can be used. The shading model map is image data having a greater pixel value for the area that is to be brightened more by the lighting effect. When the lighting effect is to be applied to the image by using the shading model map, the information processing apparatus 1 firstly selects a shading model map corresponding to a lighting effect specified by the user. By fitting the shading model to the object in the target image to which the lighting effect is to be applied, the information processing apparatus 1 generates shading image data representing a shading image as illustrated in FIG. 21B. As an example of the fitting processing, there is provided a method for adjusting a position of the shading model with that of the object based on a feature point such as a face of the object and deforming the shading model map according to the outline of the object. According to the equation (9), a shade for the shading image is added to the target image to which the lighting effect is to be applied. A pixel value of the target image to which the lighting effect is to be applied is expressed as “I”, a pixel value of the shading image is expressed as “W”, and a pixel value of a corrected image is expressed as “I″”.

I″=I+αWI (9)

where “α” is a parameter for adjusting the brightness of the light source, and the parameter α can be set for the lighting effect.

Further, in the above-described exemplary embodiments, the information processing apparatus 1 includes two cameras of the main-camera 202 and the in-camera 201, as the image-capturing unit 106. However, the image-capturing unit 106 is not limited to the above-described example. For example, the information processing apparatus 1 may include only the main-camera 202.

Further, in the above-described exemplary embodiments, a color image is used as an example of a target image to which the lighting effect is to be applied. However, the target image may be a gray-scale image.

Further, in the above-described exemplary embodiments, the HDD is used as an example of the storage apparatus 111. However, the storage apparatus 111 is not limited to the above-described example. For example, the storage apparatus 111 may be a solid-state drive (SSD). Further, the storage apparatus 111 can be also implemented by a medium (storage medium) and an external storage drive for accessing the medium. A flexible disk (FD), a compact disk read only memory (CD-ROM), a digital versatile disk (DVD), a universal serial bus (USB) memory, a magneto-optical disk (MO), and a flash memory can be used as the medium.

According to an aspect of the disclosure, a lighting effect can be applied to the image through a simple operation.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2019-016306, filed Jan. 31, 2019, which is hereby incorporated by reference herein in its entirety.

What is claimed is:

1. An information processing apparatus comprising:
a first acquisition unit configured to acquire image data representing an image;
a second acquisition unit configured to acquire position information of a first object for adjusting a lighting effect applied to the image; and
a setting unit configured to set a lighting effect applied to the image based on the position information.

2. The information processing apparatus according to claim 1, wherein the position information is information indicating a position of the first object within an image-capturing range of an image-capturing unit.

3. The information processing apparatus according to claim 1, wherein the position information is information indicating a position of the first object in a real space.

4. The information processing apparatus according to claim 1, wherein the position information is information indicating a position of the first object in an image acquired by an image-capturing unit by capturing the first object.

5. The information processing apparatus according to claim 1, wherein the first object is an object in a real space.

6. The information processing apparatus according to claim 1, wherein the first object is a user's hand.

7. The information processing apparatus according to claim 1, wherein the first object is a user's face.

8. The information processing apparatus according to claim 1, wherein the first object is an object held by a user.

9. The information processing apparatus according to claim 1, further comprising a display control unit configured to display the image to which the lighting effect is applied and an icon representing the lighting effect on a same display unit.

10. The information processing apparatus according to claim 1, further comprising an application unit configured to apply the set lighting effect to the image.

11. The information processing apparatus according to claim 1, wherein the setting unit selects, based on the position information, one setting from among a plurality of predetermined settings.

12. The information processing apparatus according to claim 1, wherein the setting unit sets, based on the position information, a position of a light source that virtually illuminates a second object with light in the image represented by the image data acquired by the first acquisition unit.

13. The information processing apparatus according to claim 10, wherein the application unit changes, based on information relating to a shape of a second object, a parameter for applying the lighting effect.

14. The information processing apparatus according to claim 10, wherein the application unit, based on the position information, selects one shading model from among a plurality of predetermined shading models, and applies a lighting effect to the image represented by the image data acquired by the first acquisition unit by using the selected shading model.

15. The information processing apparatus according to claim 1,
wherein the second acquisition unit further acquires size information indicating a size of the first object in the image acquired by an image-capturing unit by capturing the first object, and
wherein the setting unit sets, based on the size information, brightness of a light source that virtually illuminates a second object with light in the image represented by the image data acquired by the first acquisition unit.

16. An information processing apparatus comprising:
a first image-capturing unit configured to capture a first object;
a second image-capturing unit different from the first image-capturing object, and configured to capture a second object; and
a display unit configured to display an image acquired by the second image-capturing unit capturing the second object,
wherein a lighting effect is applied to the image displayed on the display unit based on a movement of the first object in an image-capturing range of the first image-capturing unit.

17. An information processing method comprising:
acquiring image data representing an image;
acquiring position information of an object for adjusting a lighting effect applied to the image; and
setting a lighting effect applied to the image based on the position information.

18. An information processing method comprising:
capturing a first object;
capturing a second object; and
displaying, on a display, an image acquired by capturing the second object,
wherein a lighting effect is applied to the image displayed on the display based on a movement of the first object in an image-capturing range.

19. A non-transitory computer-readable storage medium storing instructions that, when executed by a computer, cause the computer to perform a method, the method comprising:
acquiring image data representing an image;
acquiring position information of an object for adjusting a lighting effect applied to the image; and
setting a lighting effect applied to the image based on the position information.

20. A non-transitory computer-readable storage medium storing instructions that, when executed by a computer, cause the computer to perform a method, the method comprising:
capturing a first object;
capturing a second object; and
displaying, on a display, an image acquired by capturing the second object,
wherein a lighting effect is applied to the image displayed on the display based on a movement of the first object in an image-capturing range.
